(19) United States
(12) Patent Application Publication
(10) Pub. No.: US 2025/0328376 A1
(43) Pub. Date: Oct. 23, 2025

(54) Task Management Using a Task Management Service

(71) Applicant: AT&T Intellectual Property I, L.P., Atlanta, GA (US)

(72) Inventors: Nishan Singh, Freehold, NJ (US); Saurav Paira, Kendall Park, NJ (US); Subrat Patra, Schaumburg, IL (US); Nagaraju Sheela, Rockford, IL (US); Abdulla Udaipurwala, Monroe Township, NJ (US)

(73) Assignee: AT&T Intellectual Property I, L.P., Atlanta, GA (US)

(21) Appl. No.: 18/640,361

(22) Filed: Apr. 19, 2024

(51) Int. Cl. G06F 9/48; G06F 9/54

(52) U.S. Cl. CPC G06F 9/485; G06F 9/54

(57) ABSTRACT

Task management using a task management service can include receiving a task request from a requestor, the task request including data identifying tasks that are to be performed as part of an operation; identifying the tasks that are identified in the task request; and identifying and retrieving a template policy that relates to one of the tasks included in task request. The template policy can be included in task data stored at a task data repository and can be created by an operator device. Task management also can include identifying and retrieving a template that relates to the template policy; creating a task defined by the template; executing logic that is mapped to the template; and sending, directed to the requestor, task execution output that is collected by the processor during the executing.

### BACKGROUND

Due to the proliferation of network-enabled and/or network-connected business solutions, many business units and/or companies have created various task management tools. These task management tools may couple a particular process with an actual implementation of each included task logic, but in many cases, these various systems and/or business units may define this coupling in a proprietary and/or at least a unit-specific manner. Thus, a solution for any particular business unit or company may have little to no relevance for other business units and/or other companies.

Furthermore, with the rapid growth of networking solutions to many business problems, it may be challenging to scale and maintain various solutions as the process grows. Designers or architects may not have real visibility of the actual process implementation. Moreover, vertical silos can cause additional efforts to cover the common orchestration or task management related aspects like sequencing of tasks, dynamic instances of tasks, parallel tasks, rainy day aspects like rollbacks, failure management, resuming or restarting the processes, etc. These and other challenges may slow down the time to market as well as increase cost of providing solutions.

### SUMMARY

The present disclosure is directed to task management using a task management service. A user device or other device can authenticate with a task management service and/or a server computer hosting the task management service. The user device (or other device) can create a task request, which can correspond to a request for tasks associated with a particular operation, and send the task request to the task management service. In some embodiments, the user device (or other device) can connect to the task management service via a portal or application programming interface (“API”) and create and submit the task request. In any event, the task request can specify attributes and/or a task set for the operation and can be provided to the task management service.

The task management service can identify the attributes and tasks (e.g., a task set) from the task request. The task management service can identify template policies associated with the tasks (or task set) defined by the task request. The task management service can identify and retrieve one or more templates based on the template policies. The task management service can create tasks defined in the templates. The task management service also can determine, for example based on the task definitions, what logic corresponds to the templates and the logic can be executed by the task management service. The output from the execution of the logic can be captured by the task management service and provided to the requestor that submitted the task request (e.g., the user device or other device). It should be understood that this example embodiment is illustrative, and therefore should not be construed as being limiting in any way.

From the template policy, one or more templates can be identified. For each template, one or more task definitions can be identified, with each of the task definitions defining what logic can be input into the templates. The execution API can orchestrate the execution of the logic that is defined by the task definitions as corresponding to the template that corresponds to the template policy. Put another way, the execution API can be configured to identify and access template policies that relate to a particular request (for tasks); identify templates that relate to the identified template policies; create tasks defined in the templates; and execute logic that corresponds to the given task definition mapped in the template.

According to one aspect of the concepts and technologies disclosed herein, a system is disclosed. The system can include a processor and a memory. The memory can store computer-executable instructions that, when executed by the processor, cause the processor to perform operations. The operations can include receiving a task request from a requestor. The task request can include data identifying multiple tasks that are to be performed as part of an operation. The operations further can include identifying the multiple tasks that are identified in the task request; and identifying and retrieving a template policy that relates to a task of the multiple tasks included in the task request. The template policy can be included in task data stored at a task data repository, and the task data can be created by an operator device. The operations further can include identifying and retrieving a template that relates to the template policy. The template can be included in the task data stored at the task data repository. The operations further can include creating the task that is defined by the template; and executing logic that is mapped to the template. The logic can be included in the task data that is stored at the task data repository. The operations also can include sending, directed to the requestor, task execution output that can be collected by the processor during the executing.

In some embodiments, the task request can include a task set that can include the multiple tasks. In some embodiments, the template policy can include multiple template policies, and each of the multiple template policies can relate to one of the multiple tasks. In some embodiments, the template can include multiple templates, and each of the multiple templates can relate to one of the multiple template policies. In some embodiments, executing the logic can include inputting the logic to an execution application programming interface.

In some embodiments, the operations can further include obtaining, from the operator device and during a design phase, the task data. In some embodiments, the task data further can include a product catalog, and obtaining the task data can include providing a portal with a graphical user interface via which the product catalog, the template, the template policy, and the logic are created.

According to another aspect of the concepts and technologies disclosed herein, a method is disclosed. The method can include receiving, by a computer including a processor, a task request from a requestor. The task request can include data identifying multiple tasks that are to be performed as part of an operation. The method further can include identifying, by the processor, the multiple tasks that are identified in the task request; and identifying and retrieving, by the processor, a template policy that relates to a task of the multiple tasks included in the task request. The template policy can be included in task data stored at a task data repository, and the task data can be created by an operator device. The method further can include identifying and retrieving, by the processor, a template that relates to the template policy. The template can be included in the task data stored at the task data repository. The method further can include creating, by the processor, the task that is defined by the template; and executing, by the processor, logic that is mapped to the template. The logic can be included in the task data that is stored at the task data repository. The method also can include sending, by the processor and directed to the requestor, task execution output that can be collected by the processor during the executing.

In some embodiments, the task request can include a task set that can include the multiple tasks. In some embodiments, the template policy can include multiple template policies, and each of the multiple template policies can relate to one of the multiple tasks. In some embodiments, the template can include multiple templates, and each of the multiple templates can relate to one of the multiple template policies. In some embodiments, executing the logic can include inputting the logic to an execution application programming interface.

In some embodiments, the operations can further include obtaining, from the operator device and during a design phase, the task data. In some embodiments, the task data further can include a product catalog, and obtaining the task data can include providing a portal with a graphical user interface via which the product catalog, the template, the template policy, and the logic are created.

According to yet another aspect of the concepts and technologies disclosed herein, a computer storage medium is disclosed. The computer storage medium can store computer-executable instructions that, when executed by a processor, cause the processor to perform operations. The operations can include receiving a task request from a requestor. The task request can include data identifying multiple tasks that are to be performed as part of an operation. The operations further can include identifying the multiple tasks that are identified in the task request; and identifying and retrieving a template policy that relates to a task of the multiple tasks included in the task request. The template policy can be included in task data stored at a task data repository, and the task data can be created by an operator device. The operations further can include identifying and retrieving a template that relates to the template policy. The template can be included in the task data stored at the task data repository. The operations further can include creating the task that is defined by the template; and executing logic that is mapped to the template. The logic can be included in the task data that is stored at the task data repository. The operations also can include sending, directed to the requestor, task execution output that can be collected by the processor during the executing.

In some embodiments, the task request can include a task set that can include the multiple tasks. In some embodiments, the template policy can include multiple template policies, and each of the multiple template policies can relate to one of the multiple tasks. In some embodiments, the template can include multiple templates, and each of the multiple templates can relate to one of the multiple template policies. In some embodiments, executing the logic can include inputting the logic to an execution application programming interface.

In some embodiments, the operations can further include obtaining, from the operator device and during a design phase, the task data. In some embodiments, the task data further can include a product catalog, and obtaining the task data can include providing a portal with a graphical user interface via which the product catalog, the template, the template policy, and the logic are created.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for creating task data at design time, according to an illustrative embodiment of the concepts and technologies described herein.

FIG. 3 is a flow diagram showing aspects of a method for providing task management using a task management service, according to an illustrative embodiment of the concepts and technologies described herein.

FIG. 4 is a flow diagram showing aspects of a method for executing template tasks using a task management service, according to an illustrative embodiment of the concepts and technologies described herein.

FIGS. 5A-5G are user interface diagrams showing various screen displays for providing task management using a task management service, according to some illustrative embodiments of the concepts and technologies described herein.

FIG. 6 schematically illustrates a network, according to an illustrative embodiment of the concepts and technologies described herein.

FIG. 7 is a block diagram illustrating an example computer system configured to provide task management using a task management service, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to task management using a task management service. A user device or other device can authenticate with a task management service and/or a server computer hosting the task management service. The user device (or other device) can create a task request, which can correspond to a request for tasks associated with a particular operation, and send the task request to the task management service. In some embodiments, the user device (or other device) can connect to the task management service via a portal or API and create and submit the task request. In any event, the task request can specify attributes and/or a task set for the operation and can be provided to the task management service.

The task management service can identify the attributes and tasks (e.g., a task set) from the task request. The task management service can identify template policies associated with the tasks (or task set) defined by the task request. The task management service can identify and retrieve one or more templates based on the template policies. The task management service can create tasks defined in the templates. The task management service also can determine, for example based on the task definitions, what logic corresponds to the templates and the logic can be executed by the task management service. The output from the execution of the logic can be captured by the task management service and provided to the requestor that submitted the task request (e.g., the user device or other device). It should be understood that this example embodiment is illustrative, and therefore should not be construed as being limiting in any way.

From the template policy, one or more templates can be identified. For each template, one or more task definitions can be identified, with each of the task definitions defining what logic can be input into the templates. The execution API can orchestrate the execution of the logic that is defined by the task definitions as corresponding to the template that corresponds to the template policy. Put another way, the execution API can be configured to identify and access template policies that relate to a particular request (for tasks); identify templates that relate to the identified template policies; create tasks defined in the templates; and execute logic that corresponds to the given task definition mapped in the template.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

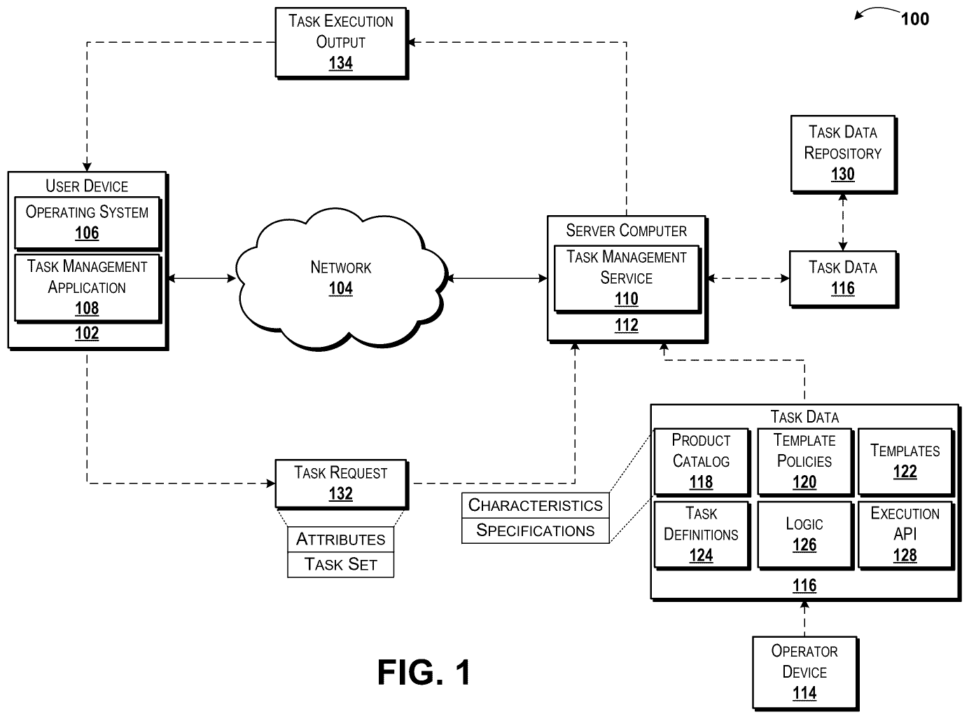

Referring now to FIG. 1, aspects of an operating environment 100 for various embodiments of the concepts and technologies disclosed herein for task management using a task management service will be described, according to an illustrative embodiment. The operating environment 100 shown in FIG. 1 includes a user device 102. The user device 102 can operate in communication with and/or as part of a communications network (“network”) 104, though this is not necessarily the case.

According to various embodiments, the functionality of the user device 102 may be provided by one or more server computers, desktop computers, mobile telephones, laptop computers, gateway devices, routers, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a personal computer. It should be understood that this embodiment is illustrative, and should not be construed as being limiting in any way.

The user device 102 can execute an operating system 106 and one or more application programs such as, for example, a task management application 108. The operating system 106 can include a computer program that can control the operation of the user device 102. The task management application 108 can include an executable program that can be configured to execute on top of the operating system 106 to provide various functions as illustrated and described herein for providing task management. Prior to describing the functionality of the task management application 108 in detail, the other entities shown in the operating environment 100 illustrated in FIG. 1 will be introduced.

As shown in FIG. 1, the operating environment 100 also can include a task management service 110, which can be hosted and/or executed by a server computer 112. According to various embodiments of the concepts and technologies disclosed herein, the functionality of the server computer 112 may be provided by one or more server computers, application servers, web servers, data processing resources, gateway devices, routers, other computing systems, and the like. It should be understood that the functionality of the server computer 112 may be provided by a single device, by two or more similar devices, and/or by two or more dissimilar devices. For purposes of describing the concepts and technologies disclosed herein, the server computer 112 is described herein as an application server. It should be understood that this embodiment is illustrative, and should not be construed as being limiting in any way.

As shown in FIG. 1, the operating environment 100 also can include an operator device 114. The operator device 114 can correspond to a device used and/or managed by a network operator, engineer, technician, or the like, for communicating with and/or configuring the task management service 110. According to various embodiments, the functionality of the operator device 114 may be provided by one or more desktop computers, mobile telephones, laptop computers, other computing systems, and the like. It should be understood that the functionality of the operator device 114 may be provided by a single device, by two or more similar devices, and/or by two or more dissimilar devices. For purposes of describing the concepts and technologies disclosed herein, the operator device 114 is described herein as a personal computer. It should be understood that this embodiment is illustrative, and should not be construed as being limiting in any way.

According to various embodiments of the concepts and technologies disclosed herein, the operator device 114 and the user device 102 can be two different devices associated with two or more entities and/or can be the same device operated by the same and/or different entities. As such, it should be understood that the functionality illustrated and described herein with respect to the user device 102 and/or the operator device 114 can be performed by one or more of the user device 102 and/or the operator device 114. It should be understood that this example embodiment is illustrative, and therefore should not be construed as being limiting in any way.

The operator device 114 can be configured to access the task management service 110 via a portal, application programming interface (“API”), and/or other functionality, which may be exposed by the server computer 112. As shown in FIG. 1, the operator device 114 can be used at a design time and/or at other times to create and/or submit, via and/or to the task management service 110, various types of data and/or data structures that can be used to provide task management using the task management service 110. As shown in FIG. 1, the operator device 114 can be configured to create and/or submit, via and/or to the task management service 110, task data 116. The task data 116 can include and/or can correspond to, a product catalog 118, one or more template policies 120, one or more templates 122, one or more task definitions 124, logic 126, and an execution API 128. Because the task data 116 can include additional and/or alternative components, it should be understood that this example embodiment is illustrative, and therefore should not be construed as being limiting in any way.

The product catalog 118 can correspond to a data structure that can define multiple products in terms of specifications and capabilities of the products. The specifications can include interface design for exposing capabilities of the products, and the characteristics can correspond to a data model that includes the specifications (e.g., the service type). Thus, it can be appreciated that the product catalog 118 can define products in terms of design and service type specifics (e.g., type of service, bandwidth, etc.). Because specifications and characteristics of a product can be defined in additional and/or alternative manners, it should be understood that this example embodiment of the product catalog 118 (where the products are defined in terms of specifications and characteristics) is an example embodiment and should not be construed as being limiting in any way.

The template policies 120 can include data and/or data structures that can represent one or more use cases for a product and/or operation. Thus, for example, if a user or other entity is attempting to create a data storage resource (for example), a template policy 120 for data storage resource creation can be obtained as a use case, and the template policy 120 can be analyzed to determine tasks associated with the use case. It should be understood that this example embodiment is illustrative, and therefore should not be construed as being limiting in any way.

The templates 122 can include data and/or data structures for representing a collection of tasks/steps/activities required for a particular operation or request. Thus, it can be appreciated that a template policy 120 can define multiple steps or operations, and the templates 122 can further define steps and/or activities for the use case represented by the template policy 120. It should be understood that this example embodiment is illustrative, and therefore should not be construed as being limiting in any way.

The task definitions 124 can include data and/or a data structure that can correspond to an abstract that exposes logic 126 that can be input into any template 122. Thus, a task definition 124 can define what logic 126 can be input into a template 122. It should be understood that this example embodiment is illustrative, and therefore should not be construed as being limiting in any way.

The logic 126 can include business logic for providing a particular task, event, or the other portion of an operation. Thus, for example, in the example of establishing a virtual service, a particular task or event may include instantiating a data storage resource to host or store the instructions associated with the virtual service. The logic 126 can correspond to operations that can be performed to instantiate the data storage resource. It should be understood that this example embodiment is illustrative, and therefore should not be construed as being limiting in any way.

The execution API 128 can include a framework that can orchestrate a set of tasks for a particular operation or request. Thus, it can be appreciated that for a particular operation that is being requested by a user or other entity, a template policy 120 can be identified. From the template policy 120, one or more templates 122 can be identified. For each template 122, one or more task definitions 124 can be identified, with each of the task definitions 124 defining what logic 126 can be input into the templates 122. The execution API 128 can orchestrate the execution of the logic 126 that is defined by the task definitions 124 as corresponding to the template 122 that corresponds to the template policy 120. Put another way, the execution API 128 can be configured to identify and access template policies 120 that relate to a particular request (for tasks); identify templates 122 that relate to the identified template policies 120; create tasks defined in the templates 122; and execute logic 126 that corresponds to the given task definition 124 mapped in the template 122. It should be understood that this example embodiment is illustrative, and therefore should not be construed as being limiting in any way.

Embodiments of the concepts and technologies disclosed herein can therefore be used to standardize business task execution and/or to enable reusing, recycling, and/or sharing of tasks across business units and organizations. Because certain tasks can be standardized, reused, recycled, etc., business operations in general can be streamlined, improved, and made more efficient. It should be understood that this example embodiment is illustrative, and therefore should not be construed as being limiting in any way.

The task management service 110 can be configured to receive the task data 116 from the operator device 114 and/or other devices, for example, at a design time and/or at other times. The task management service 110 can be configured to save the task data 116 in a data storage device or resource such as, for example, a task data repository 130. The functionality of the task data repository 130 can be provided by databases, server computers, desktop computers, laptop computers, other computing systems, and the like. In the illustrated embodiments, the functionality of the task data repository 130 is provided by a data server that operates in communication with and/or as a part of the network 104. It should be understood that this example embodiment is illustrative, and therefore should not be construed as being limiting in any way.

The task management service 110 can be configured to receive, from the user device 102, a task request 132. The task request 132 can be generated by the user device 102 (e.g., via execution of the task management application 108) and transmitted to the server computer 112 by the user device 102. According to various embodiments of the concepts and technologies disclosed herein, the task management application 108 can be configured to generate the task request 132 based on input of a user or other entity. The task request 132 can specify one or more attributes and/or one or more tasks associated with a particular operation that is being completed and/or requested by the task management application 108. Thus, for example, if a user or other entity determines that a particular operation is desired, the task request 132 can comprise data that, when analyzed by the task management service 110, can be interpreted as requesting the set of tasks associated with the specified operation.

By way of example, a user or other entity may want to create a new circuit for use at a particular site. Via interactions with the task management application 108, the user or other entity can effectively request the tasks associated with that operation (creation of the new circuit). It can be appreciated that the task sets and/or other aspects of the tasks of the operation can be defined and/or configured at any time, and reflected in the stored task data 116 and/or the components thereof. It should be understood that this example embodiment is illustrative, and therefore should not be construed as being limiting in any way.

In response to receiving the task request 132, the task management service 110 can analyze the task request 132 and identify one or more attributes and/or tasks associated with the task request 132. The task management service 110 can access the task data 116 and identify, based on the components of the task data 116, one or more tasks that are to be executed in association with the operation defined by the task request 132 (e.g., in the above example this operation includes creating a new circuit). It should be understood that this example embodiment is illustrative, and therefore should not be construed as being limiting in any way.

The task management service 110 can obtain the tasks associated with the operation and arrange and/or provide task execution in association with the operation. According to various embodiments, task execution can include the task management service 110 identifying and retrieving one or more template policies 120 based on the task request 132. Based on the identified and retrieved template policies 120, the task management service 110 can identify and retrieve one or more templates 122. The task management service 110 can create, based on the one or more templates 122, one or more tasks that are to be executed and/or implemented to provide the operation associated with the task request 132. It can be appreciated that the definition of the tasks can be based on the task definitions 124, which can be referenced in the templates 122. It should be understood that this example embodiment is illustrative, and therefore should not be construed as being limiting in any way.

Once the tasks are identified by the task management service 110, the task management service 110 can execute the identified tasks using the logic 126. It can be appreciated that the logic 126 can be executed by the task management service 110 via one or more execution APIs such as the execution API 128. Thus, the task management service 110 can execute the logic 126 that corresponds to the one or more task definitions 124 mapped to the templates 122. It should be understood that this example embodiment is illustrative, and therefore should not be construed as being limiting in any way.

As such, the task management service 110 can provide not only task identification, but also task execution for requesters such as the user device 102. It therefore can be appreciated that a user or other entity can indicate an operation that is to be performed or is being performed, and via execution of the task management application 108, generate a task request 132 for obtaining tasks and/or execution of the tasks. After executing the tasks, the task management service 110 can send the task execution output 134 to the user device 102. As such, the user or other entity at the user device 102 can specify an operation to be completed, which can prompt the task management application 108 to generate the task request 132. The task request 132 can be sent to the task management service 110, and the task management service 110 can identify and execute the tasks associated with the operation, and return task execution output 134 to the user device 102. It should be understood that this example embodiment is illustrative, and therefore should not be construed as being limiting in any way.

In practice, a user device 102 or other device can authenticate with the task management service 110 and/or a server computer 112 hosting the task management service 110. The user device 102 (or other device) can create a task request 132, which can correspond to a request for tasks associated with a particular operation, and send the task request 132 to the task management service 110. In some embodiments, the user device 102 (or other device) can connect to the task management service 110 via a portal or API and create and submit the task request 132. In any event, the task request 132 can specify attributes and/or a task set for the operation and can be provided to the task management service 110.

The task management service 110 can identify the attributes and tasks (e.g., a task set) from the task request 132. The task management service 110 can identify template policies 120 associated with the tasks (or task set) defined by the task request 132. The task management service 110 can identify and retrieve one or more templates 122 based on the template policies 120. The task management service 110 can create tasks defined in the templates 122. The task management service 110 also can determine, for example based on the task definitions 124, what logic 126 corresponds to the templates 122 and the logic 126 can be executed by the task management service 110. The output from the execution of the logic 126 can be captured by the task management service 110 and provided to the requestor that submitted the task request 132 (e.g., the user device 102 or other device). It should be understood that this example embodiment is illustrative, and therefore should not be construed as being limiting in any way.

From the template policy 120, one or more templates 122 can be identified. For each template 122, one or more task definitions 124 can be identified, with each of the task definitions 124 defining what logic 126 can be input into the templates 122. The execution API 128 can orchestrate the execution of the logic 126 that is defined by the task definitions 124 as corresponding to the template 122 that corresponds to the template policy 120. Put another way, the execution API 128 can be configured to identify and access template policies 120 that relate to a particular request (for tasks); identify templates 122 that relate to the identified template policies 120; create tasks defined in the templates 122; and execute logic 126 that corresponds to the given task definition 124 mapped in the template 122.

FIG. 1 illustrates one user device 102, one network 104, one server computer 112, one operator device 114, and one task data repository 130. It should be understood, however, that various implementations of the operating environment 100 can include zero, one, or more than one user device 102; zero, one, or more than one network 104; zero, one, or more than one server computer 112; zero, one, or more than one operator device 114; and/or zero, one, or more than one task data repository 130. As such, the illustrated embodiment should be understood as being illustrative, and should not be construed as being limiting in any way.

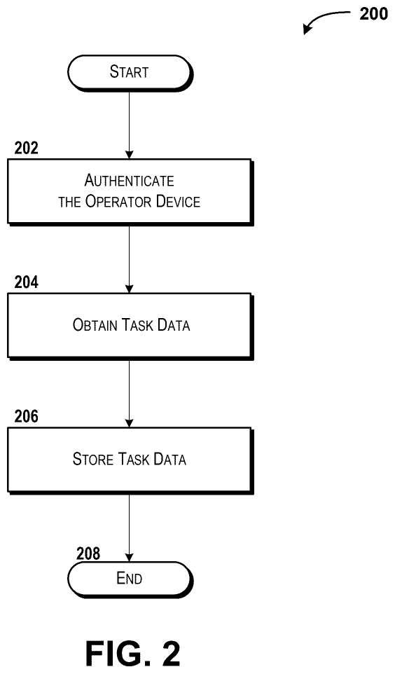

Turning now to FIG. 2, aspects of a method 200 for creating task data at design time will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102, the server computer 112, and/or the operator device 114, to perform one or more operations and/or causing the processor to direct other components of the computing system or device to perform one or more of the operations.

For purposes of illustrating and describing the concepts of the present disclosure, the method 200 is described herein as being performed by the server computer 112 via execution of one or more software modules such as, for example, the task management service 110. It should be understood that additional and/or alternative devices and/or network nodes can provide the functionality described herein via execution of one or more modules, applications, and/or other software including, but not limited to, the task management service 110. Thus, the illustrated embodiments are illustrative, and should not be viewed as being limiting in any way.

The method 200 begins at operation 202. In operation 202, the server computer 112 can authenticate the operator device 114 or other device that connects to the server computer 112 via the portal and/or API as illustrated and described herein. According to various embodiments of the concepts and technologies disclosed herein, the task management service 110 can be configured to authenticate a user or device that attempts to connect to the task management service 110 (e.g., the operator device 114, the user device 102, and/or other devices and/or entities). As such, a device attempting to create task data 116 with the server computer 112 may send a command or request for the interactions. The command or request can be sent with authentication information in some embodiments and/or the server computer 112 can expose an API or portal for generating the task data 116, wherein a device or user attempting to create the task data 116 may be required to authenticate with the task management service 110. It should be understood that this example embodiment is illustrative, and therefore should not be construed as being limiting in any way.

According to some embodiments of the concepts and technologies disclosed herein, the authentication can be provided in additional and/or alternative manners. For example, the task data 116 and/or a request to create the task data 116 can be generated using a private or public key, sent with login information, encrypted, and/or otherwise protected. In some other embodiments, the server computer 112 and the operator device 114 can be configured create a secure channel via which the task data 116 is generated and/or transmitted. Because authentication is generally understood, it can be appreciated that other authentication methods and/or processes are possible and are contemplated. As such, the illustrated embodiment is illustrative and should not be construed as being limiting in any way.

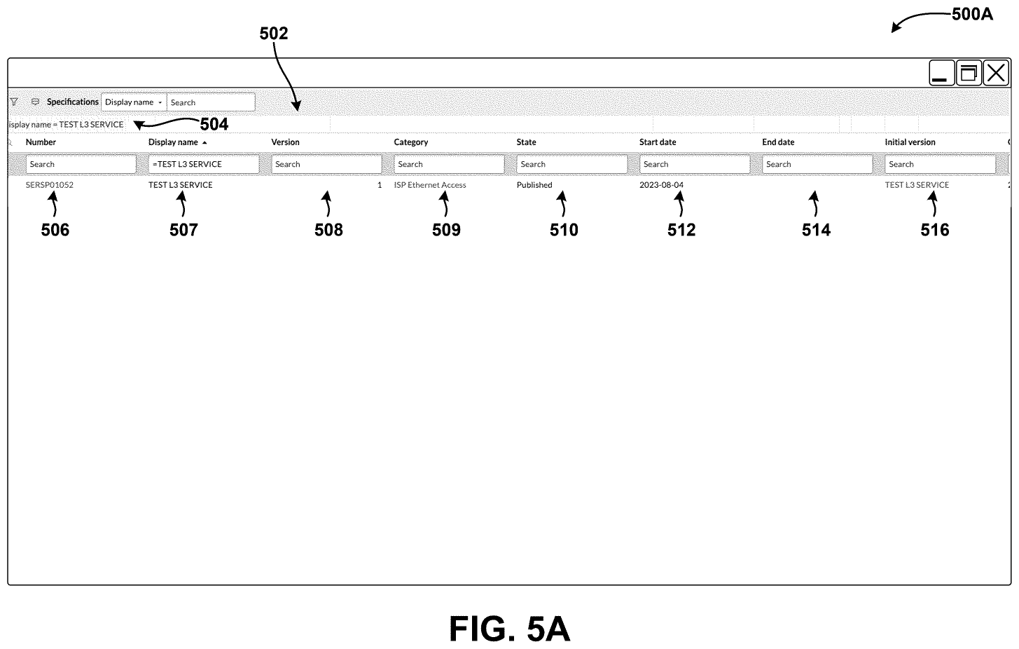

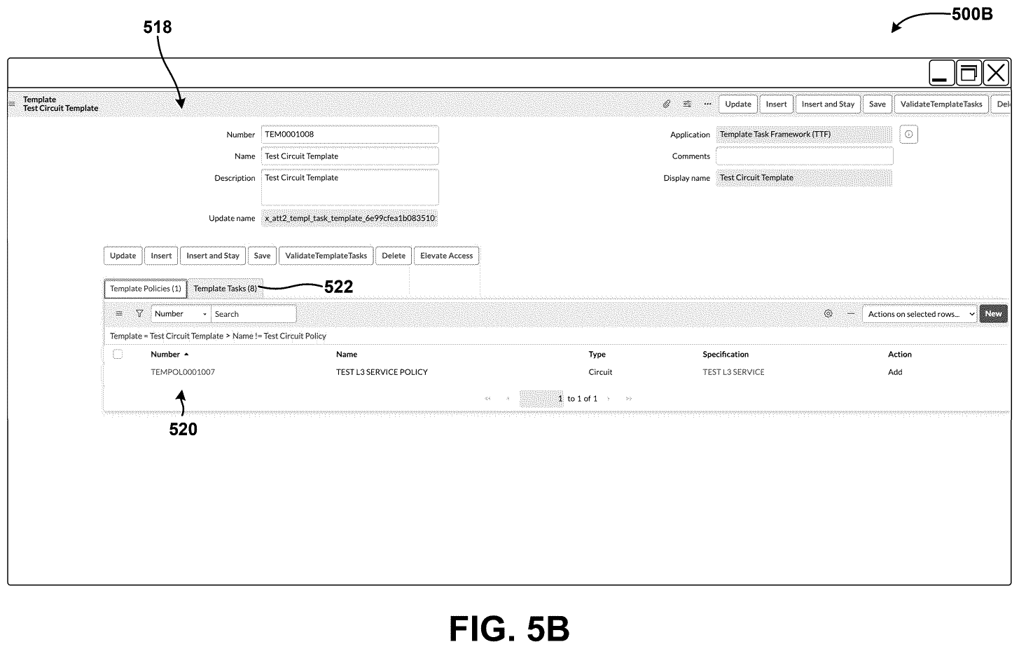

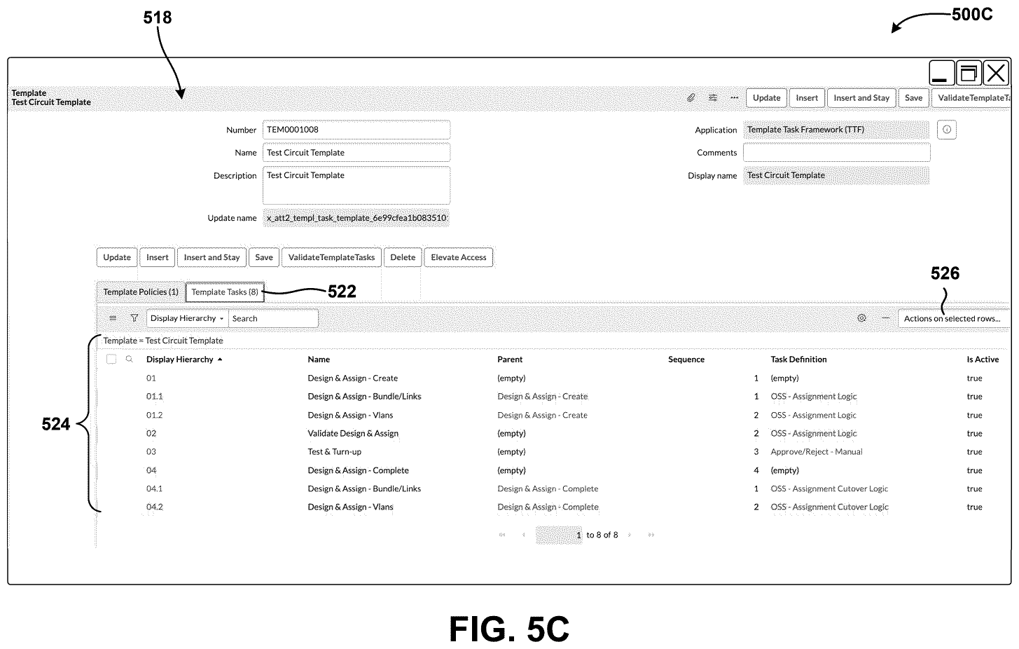

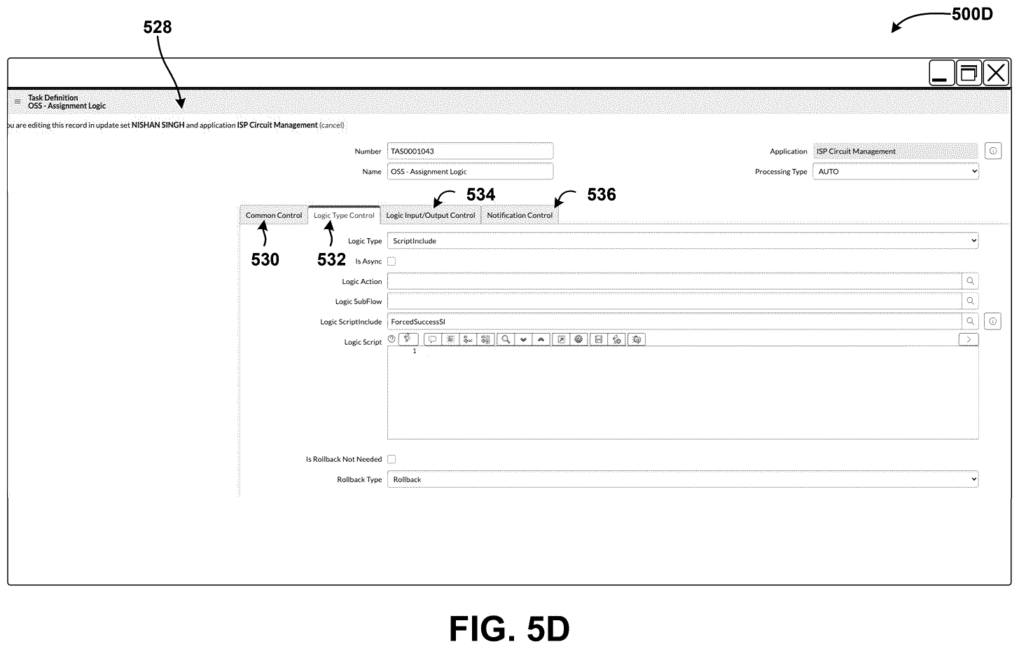

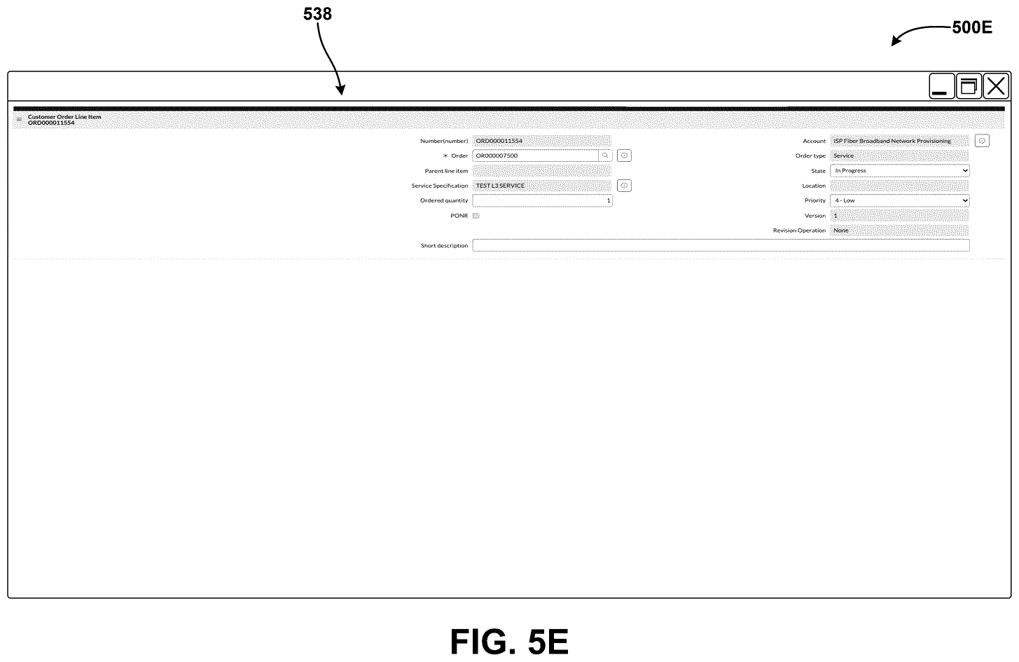

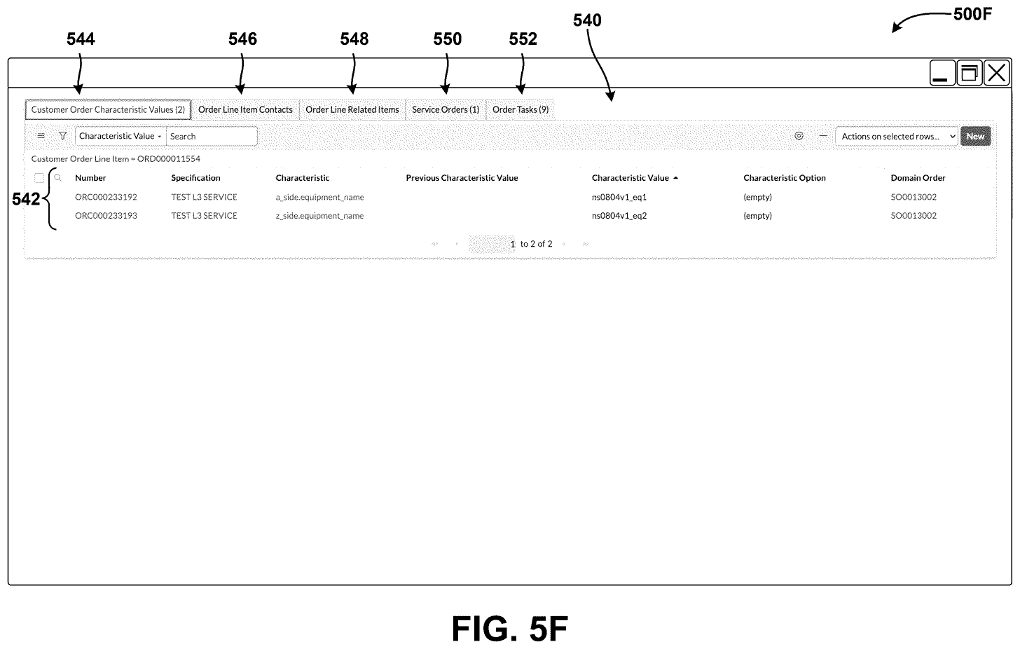

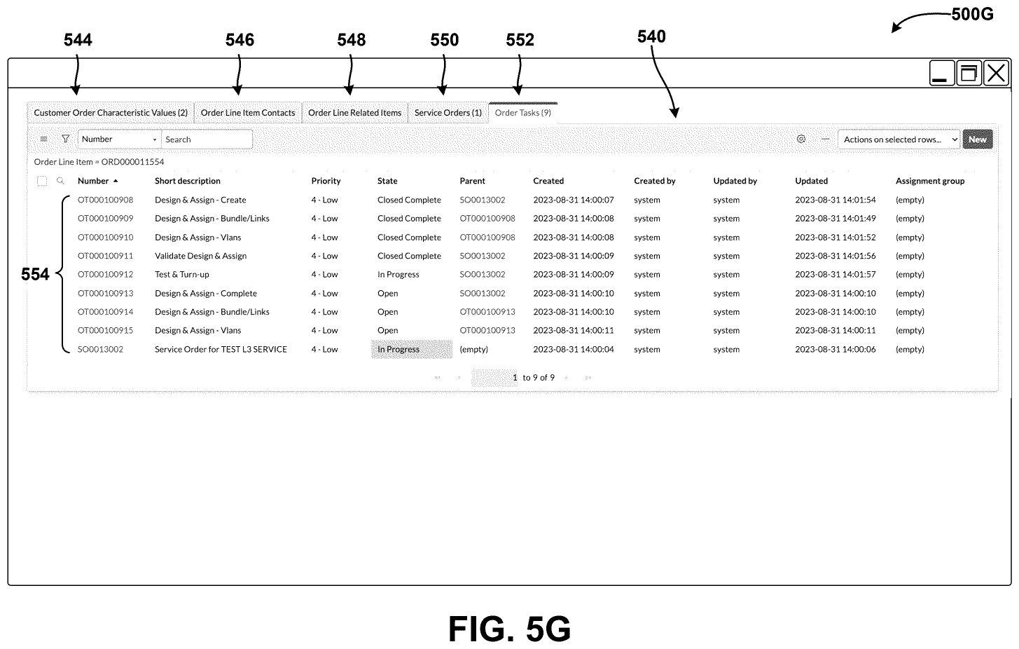

From operation 202, the method 200 can proceed to operation 204. At operation 204, the server computer 112 can obtain task data 116. According to various embodiments of the concepts and technologies disclosed herein, the server computer 112 can obtain the task data 116 from the operator device 114 and/or other devices during a design and/or setup operation or phase. In some embodiments, the server computer 112 can present various user interfaces via which the user or other entity (e.g., via the user device 102) can create the task data 116 and/or components thereof such as, for example, the product catalog 118, the template policies 120, the templates 122, the task definitions 124, the logic 126, the execution API 128, and/or other aspects of the task data 116. Some example user interfaces for collecting and/or creating the task data 116 are illustrated and described hereinbelow with reference to FIGS. 5A-5G. Because the task data 116 can be obtained at additional and/or alternative times and/or under additional and/or alternative circumstances, it should be understood that this example embodiment is illustrative, and therefore should not be construed as being limiting in any way.

The task data 116, as noted above, can include various data and/or data structures that collectively can define and/or can be used to define one or more tasks for one or more operations. Because the tasks can be defined in a standardized manner, the tasks can be recycled and/or reused for various operations in various embodiments. Thus, for example, an operation for creating a new data store at a particular site may include a task for instantiating a data storage resource. Another operation for creating a virtual machine may similarly include a task for instantiating a data storage resource. Thus, it can be appreciated that a task for “instantiating a data storage resource” can be included as a task in a task set for the operation for creating a new data store and for the operation for creating a virtual machine. It should be understood that this example embodiment is illustrative, and therefore should not be construed as being limiting in any way.

In operation 204, the task management service 110 executed and/or hosted by the server computer 112 can be used to create and/or obtain the various components of the task data 116 including, for example, one or more than one product catalog 118, one or more than one template policy 120, one or more than one template 122, one or more than one instance of logic 126, one or more than one execution API 128, and one or more than one task definition 124. Because these components of the task data 116 have been described in additional detail above, it can be appreciated that the user or other entity may interact with the server computer 112 to create the task data 116 and therefore, operation 204 can correspond to the server computer 112 hosting the interactions with the operator device 114 via the API or portal or other functionality exposed by the server computer 112. It should be understood that this example embodiment is illustrative, and therefore should not be construed as being limiting in any way.

From operation 204, the method 200 can proceed to operation 206. At operation 206, the server computer 112 can store the task data 116 obtained in operation 202. It can be appreciated that in operation 204 the server computer 112 can be configured to key the task data 116 and/or otherwise store the task data 116 in a manner that can enable querying and/or retrieval based on any data point included in the task data 116 and/or based on any key included in one or more data tuples that may correspond to the task data 116 in some embodiments of the concepts and technologies disclosed herein. Regardless of how the task data 116 is sorted and/or organized, the server computer 112 can store the task data 116 in the task data repository 130 and/or other local or remote data storage resource in operation 206. It should be understood that this example embodiment is illustrative, and therefore should not be construed as being limiting in any way.

From operation 206, the method 200 can proceed to operation 208. The method 200 can end at operation 208.

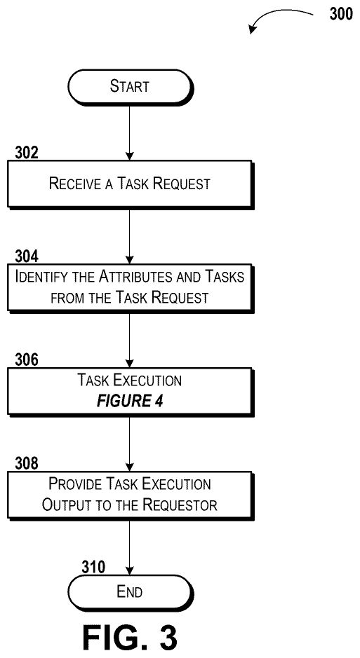

Turning now to FIG. 3, aspects of a method 300 for providing task management using a task management service will be described in detail, according to an illustrative embodiment. For purposes of illustrating and describing the concepts of the present disclosure, the method 300 is described herein as being performed by the server computer 112 via execution of one or more software modules such as, for example, the task management service 110. It should be understood that additional and/or alternative devices and/or network nodes can provide the functionality described herein via execution of one or more modules, applications, and/or other software including, but not limited to, the task management service 110. Thus, the illustrated embodiments are illustrative, and should not be viewed as being limiting in any way.

The method 300 begins at operation 302. At operation 302, the server computer 112 can receive a task request 132. According to various embodiments of the concepts and technologies disclosed herein, the task request 132 can be received from the user device 102 and/or other devices. As explained above, the task request 132 can correspond to a request for one or more tasks associated with a particular operation. Thus, the task request 132 can identify one or more attributes and/or one or more tasks associated with the operation that is being completed and/or requested by, for example, the user device 102. As such, the task request 132 can be analyzed by the task management service 110 and used to determine one or more tasks that are to be performed. It should be understood that this example embodiment is illustrative, and therefore should not be construed as being limiting in any way.

From operation 302, the method 300 can proceed to operation 304. At operation 304, the server computer 112 can identify, by analyzing the task request 132, one or more tasks and/or one or more attributes associated with the task request 132. In some embodiments of the concepts and technologies disclosed herein, the tasks and/or attributes can be explicitly included in the task request 132, and as such, the server computer 112 can identify the tasks and/or attributes by analyzing and/or parsing the task request 132. In some other embodiments, the tasks and/or attributes may be determined by the server computer 112 by accessing the task data 116 (e.g., stored at the task data repository 130) based on the task request 132 and/or one or more components thereof. Because the server computer 112 can identify the tasks and/or attributes in additional and/or alternative manners, it should be understood that these example embodiments are illustrative, and therefore should not be construed as being limiting in any way.

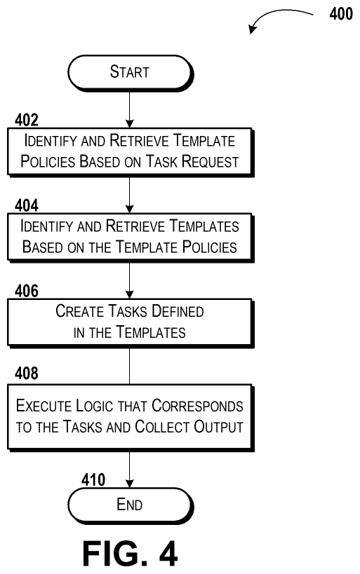

From operation 304, the method 300 can proceed to operation 306. At operation 306, the server computer 112 can perform task execution by executing and/or triggering execution of one or more tasks identified by the server computer 112. Additional details of the task execution will be illustrated and described hereinbelow with reference to FIG. 4. Briefly, however, operation 306 can include the server computer 112 identifying tasks and executing and/or triggering execution of the identified tasks. It should be understood that this example embodiment is illustrative, and therefore should not be construed as being limiting in any way.

From operation 306, the method 300 can proceed to operation 308. At operation 308, the server computer 112 can provide task execution output 134 to the requestor (e.g., to the entity that sent, triggered delivery of, and/or generated the task request 132 in operation 302). As such, it can be appreciated that via execution of the operations of the method 300, a user device 102 or other entity can request task execution and obtain task execution output 134 based on a task request 132. It should be understood that this example embodiment is illustrative, and therefore should not be construed as being limiting in any way.

From operation 308, the method 300 can proceed to operation 310. The method 300 can end at operation 310.

Turning now to FIG. 4, aspects of a method 400 for executing template tasks using a task management service will be described in detail, according to an illustrative embodiment. For purposes of illustrating and describing the concepts of the present disclosure, the method 400 is described herein as being performed by the server computer 112 via execution of one or more software modules such as, for example, the task management service 110. It should be understood that additional and/or alternative devices and/or network nodes can provide the functionality described herein via execution of one or more modules, applications, and/or other software including, but not limited to, the task management service 110. Thus, the illustrated embodiments are illustrative, and should not be viewed as being limiting in any way.

As illustrated and described above with reference to FIG. 3, the method 400 can be performed by the server computer 112 in association with the execution of operation 306 in the method 300 in some embodiments. Because the functionality illustrated and described herein with reference to FIG. 4 can be performed at additional and/or alternative times, it should be understood that this example embodiment is illustrative, and therefore should not be construed as being limiting in any way.

The method 400 begins at operation 402. At operation 402, the server computer 112 can identify and retrieve one or more than one template policy 120 based on the task request 132 received in operation 302. Although FIG. 4 indicates identifying and retrieving multiple template policies 120 in operation 402, it should be understood that one or more template policies 120 can be identified and retrieved. According to various embodiments of the concepts and technologies disclosed herein, the server computer 112 can analyze the task request 132 and determine, based on the task request 132, one or more tasks associated with the task request 132. As noted above, the tasks can be identified explicitly and/or implicitly based on information in the task request 132.

The server computer 112 can query the task data 116 stored in the task data repository 130 to identify and retrieve the template policies 120 associated with the tasks identified by the server computer 112. Thus, operation 402 can include the server computer 112 identifying the tasks from the task request 132 and identifying and retrieving the template policies 120 associated with the identified tasks. It should be understood that this example embodiment is illustrative, and therefore should not be construed as being limiting in any way.

From operation 402, the method 400 can proceed to operation 404. At operation 404, the server computer 112 can identify one or more templates 122 based on the one or more template policies 120 identified and retrieved in operation 402. Thus, the server computer 112 can again access the task data 116 stored in the task data repository 130 in operation 404 to identify, based on the identified template policies 120, one or more templates 122. It should be understood that this example embodiment is illustrative, and therefore should not be construed as being limiting in any way.

From operation 404, the method 400 can proceed to operation 406. At operation 406, the server computer 112 can create the tasks defined in the one or more templates 122 determined in operation 404. Thus, the server computer 112 can again access the task data 116 stored in the task data repository 130 in operation 406 and create the tasks that are defined in the templates 122. Thus, for example, if a template 122 includes any number of tasks, operation 406 can include the server computer 112 identifying each of the tasks and retrieving the tasks. It should be understood that this example embodiment is illustrative, and therefore should not be construed as being limiting in any way.

From operation 406, the method 400 can proceed to operation 408. At operation 408, the server computer 112 can execute logic 126 that can correspond to the tasks created in operation 406 and can collect output from the execution of the logic. It can be appreciated that the server computer 112 can enable execution of the tasks via the execution API 128, if desired. In any event, the server computer 112 can enable the execution and can collect output from the execution of the logic in operation 408. Based on the above-described method 300 of FIG. 3, it can be appreciated that the output collected in operation 408 can be correspond to the task execution output 134. The server computer 112 can collect the task execution output 134 in operation 408 and send the task execution output 134 to the requestor (e.g., the device that sent the task request 132) in operation 308 of the method 300. It should be understood that this example embodiment is illustrative, and therefore should not be construed as being limiting in any way.

From operation 408, the method 400 can proceed to operation 410. The method 400 can end at operation 410.

FIGS. 5A-5G are user interface (“UI”) diagrams showing aspects of UIs for using and/or interacting with task management service 110 to provide various aspects of task management as illustrated and described herein, according to some illustrative embodiments. FIG. 5A shows an illustrative screen display 500A. According to some embodiments of the concepts and technologies described herein, the screen display 500A can be generated by a device such as the user device 102 and/or the operator device 114 via interactions with the task management service 110 and/or the task management application 108. In particular, according to various embodiments, the user device 102 can generate the screen display 500A and/or other screen displays in conjunction with and/or based upon interactions with the task management service 110 to submit the task data 116 as illustrated and described herein. The user device 102 and/or the operator device 114 can be configured to render the screen display 500A using data generated and/or rendered at the user device 102 and/or the operator device 114 (e.g., using data provided by the task management service 110). Because the screen display 500A illustrated in FIG. 5A can be displayed at additional and/or alternative times, it should be understood that these examples are illustrative and therefore should not be construed as being limiting in any way.

The screen display 500A can include various menus and/or menu options (not shown in FIG. 5A). The screen display 500A also can include a product design window 502. The product design window 502 can be configured to enable a user or other entity to create and/or navigate through task data 116 including browsing and/or selecting items in a product catalog 118, creating and/or using template policies 120, creating and/or using templates 122, creating and/or refining task definitions 124, and/or selecting tasks for execution at various times. The product design window 502 can include various types of data and/or information that can be defined by a user or other entity.

Thus, as illustrated and described herein, the product design window 502 can include a product catalog title 504 for titling an object in the product catalog 118; a product identifier 506 for viewing, modifying, or assigning a product identifier to the product from the product catalog 118; a display name 507 (which can correspond to the product catalog title 504); a version information area 508 for displaying versioning and/or revision history information; a category area 509 for categorizing the product; a status area 510 for communicating status of the product; a start data area 512 for displaying a start date from which the product was created and/or available; an end date area 514 for displaying an end date for the product (in the illustrated embodiment no end date is specified); and an initial version data 516 for communicating initial version information. Thus, the product design window 502 can provide and/or enable creation and/or modification of various aspects of a product for which tasks are being defined. Because additional or alternative controls can be included in the product design window 502, it should be understood that the example embodiment shown in FIG. 5A is illustrative and therefore should not be construed as being limiting in any way.

FIG. 5B shows an illustrative screen display 500B. According to some embodiments of the concepts and technologies described herein, the screen display 500B can be generated by a device such as the user device 102 and/or the operator device 114 via interactions with the task management service 110 and/or the task management application 108. In particular, according to various embodiments, the user device 102 can generate the screen display 500B and/or other screen displays in conjunction with and/or based upon interactions with the task management service 110 to submit the task data 116 as illustrated and described herein. The user device 102 and/or the operator device 114 can be configured to render the screen display 500B using data generated and/or rendered at the user device 102 and/or the operator device 114 (e.g., using data provided by the task management service 110). Because the screen display 500B illustrated in FIG. 5B can be displayed at additional and/or alternative times, it should be understood that these examples are illustrative and therefore should not be construed as being limiting in any way.

The screen display 500B can include various menus and/or menu options (not shown in FIG. 5B). The screen display 500B also can include a template design window 518. The template design window 518 can be configured to enable a user or other entity to create and/or navigate through task data 116 including creating, modifying, browsing through, and/or selecting items in template policies 120. The template design window 518 can include various types of data and/or information that can be defined by a user or other entity as illustrated and described herein.

Thus, as illustrated and described herein, the template design window 518 can include a template policy embed window 520 for defining one or more templates 122 for a particular product in the product catalog 118. As can be appreciated with reference to FIG. 5B, the template design window 518 can include options for taking various actions on the products such as updating templates 122, inserting templates 122, saving products, validating template tasks, deleting templates, managing access, inserting templates, combinations thereof, or the like. Because additional and/or alternative options can be included, it should be understood that these example embodiments are illustrative, and therefore should not be construed as being limiting in any way.

The template policy embed window 520 also can list one or more template policies 120 defined for a particular product and/or other information associated with the product. It can be appreciated that in some embodiments, an option 522 to view the template tasks associated with the template can be displayed in the template policy embed window 520. Selection of the option 522 to view the template tasks can cause the user device 102, the operator device 114, and/or other device displaying the screen display 500B to update the template design window 510 to show the template tasks. Thus, the template design window 518 can provide and/or enable creation and/or modification of various templates 122 associated with a product for which tasks are being defined. Because additional or alternative controls can be included in the template design window 518, it should be understood that the example embodiment shown in FIG. 5B is illustrative and therefore should not be construed as being limiting in any way.

FIG. 5C shows an illustrative screen display 500C. According to some embodiments of the concepts and technologies described herein, the screen display 500C can be generated by a device such as the user device 102 and/or the operator device 114 via interactions with the task management service 110 and/or the task management application 108. In particular, according to various embodiments, the user device 102 can generate the screen display 500C and/or other screen displays in conjunction with and/or based upon interactions with the task management service 110 to submit the task data 116 as illustrated and described herein. The user device 102 and/or the operator device 114 can be configured to render the screen display 500C using data generated and/or rendered at the user device 102 and/or the operator device 114 (e.g., using data provided by the task management service 110). In the illustrated embodiment, the screen display 500C can be displayed, for example, in response to a user or other entity selecting the option 522 to view the template tasks as shown in FIG. 5B. Because the screen display 500C illustrated in FIG. 5C can be displayed at additional and/or alternative times, it should be understood that this example is illustrative and therefore should not be construed as being limiting in any way.

The screen display 500C can include various menus and/or menu options (not shown in FIG. 5C). The screen display 500C also can include the template design window 518. The template design window 518 has been updated to show a task list 524. The task list 524 can list and show the tasks associated with the template 122 being viewed in the template design window 518. This task list can include a selectable interface by which a user can select a row (i.e., a task) and then take a desired action on a task via selection of the task action menu option 526. It can be appreciated that the task action menu option 526 can include actions such as creating a new task, editing a task, deleting a task, validating a task, combinations thereof, or the like. Thus, the template design window 518 can provide and/or enable creation and/or modification of various templates 122 associated with a product for which tasks are being defined. Because additional or alternative controls can be included in the template design window 518, it should be understood that the example embodiment shown in FIG. 5C is illustrative and therefore should not be construed as being limiting in any way.

FIG. 5D shows an illustrative screen display 500D. According to some embodiments of the concepts and technologies described herein, the screen display 500D can be generated by a device such as the user device 102 and/or the operator device 114 via interactions with the task management service 110 and/or the task management application 108. In particular, according to various embodiments, the user device 102 can generate the screen display 500D and/or other screen displays in conjunction with and/or based upon interactions with the task management service 110 to submit the task data 116 as illustrated and described herein. The user device 102 and/or the operator device 114 can be configured to render the screen display 500D using data generated and/or rendered at the user device 102 and/or the operator device 114 (e.g., using data provided by the task management service 110). In the illustrated embodiment, the screen display 500D can be displayed, for example, in response to a user or other entity selecting an option to assign logic 126 to a particular task (e.g., one of the template tasks as shown in FIGS. 5B-5C). Because the screen display 500D illustrated in FIG. 5D can be displayed at additional and/or alternative times, it should be understood that this example is illustrative and therefore should not be construed as being limiting in any way.

The screen display 500D can include various menus and/or menu options (not shown in FIG. 5D). The screen display 500D also can include the logic assignment window 528. According to various embodiments of the concepts and technologies disclosed herein, the logic assignment window 528 can be used to assign logic 126 to one or more tasks. As can be seen in FIG. 5D, the logic assignment window 528 can include an option 530 to create, configure, and/or modify common control logic for a particular task; an option 532 to create, configure, and/or modify logic type control for a task; an option 534 to create, configure, and/or modify input/output control particulars for the logic 126 that has been assigned to a particular task; and an option 536 to create, configure, and/or modify notifications relating to the logic execution. Thus, the logic assignment window 528 can provide and/or enable creation and/or modification of various logic 126 that is to be executed in association with a particular product for which tasks are being defined. Because additional or alternative controls can be included in the logic assignment window 528, it should be understood that the example embodiment shown in FIG. 5D is illustrative and therefore should not be construed as being limiting in any way.

FIG. 5E shows an illustrative screen display 500E. According to some embodiments of the concepts and technologies described herein, the screen display 500E can be generated by a device such as the user device 102 and/or the operator device 114 via interactions with the task management service 110 and/or the task management application 108. In particular, according to various embodiments, the user device 102 can generate the screen display 500E and/or other screen displays in conjunction with and/or based upon interactions with the task management service 110 to submit the task data 116 as illustrated and described herein. The user device 102 and/or the operator device 114 can be configured to render the screen display 500E using data generated and/or rendered at the user device 102 and/or the operator device 114 (e.g., using data provided by the task management service 110). In the illustrated embodiment, the screen display 500E can be displayed, for example, in response to a user or other entity selecting an option to create an order and/or to add a line item to an order (e.g., to add a task to an order such as one of the template tasks as shown in FIGS. 5B-5C). Because the screen display 500E illustrated in FIG. 5E can be displayed at additional and/or alternative times, it should be understood that this example is illustrative and therefore should not be construed as being limiting in any way.

The screen display 500E can include various menus and/or menu options (not shown in FIG. 5E). The screen display 500E also can include the order creation window 538. According to various embodiments of the concepts and technologies disclosed herein, the order creation window 538 can be used to define various aspects of an order. As can be seen in FIG. 5E, the order creation window 538 can include fields for defining names, order numbers, line item in formation and/or inherency information, service specification (where tasks and/or task templates can be tied to the order), quantity fields, account information for a purchaser, order type information, state/status information for the order, location information, priority definition fields, version information, revision information, and/or other options and/or fields for defining order particulars. Thus, the order creation window 538 can provide and/or enable creation and/or modification of various aspects of an order that is being created by way of interacting with the task management service 110. Because additional or alternative controls can be included in the order creation window 538, it should be understood that the example embodiment shown in FIG. 5E is illustrative and therefore should not be construed as being limiting in any way.

FIG. 5F shows an illustrative screen display 500F. According to some embodiments of the concepts and technologies described herein, the screen display 500F can be generated by a device such as the user device 102 and/or the operator device 114 via interactions with the task management service 110 and/or the task management application 108. In particular, according to various embodiments, the user device 102 can generate the screen display 500F and/or other screen displays in conjunction with and/or based upon interactions with the task management service 110 to submit the task data 116 as illustrated and described herein. The user device 102 and/or the operator device 114 can be configured to render the screen display 500F using data generated and/or rendered at the user device 102 and/or the operator device 114 (e.g., using data provided by the task management service 110). In the illustrated embodiment, the screen display 500F can be displayed, for example, in response to a user or other entity selecting an option to view orders and/or to edit one or more orders. Because the screen display 500F illustrated in FIG. 5F can be displayed at additional and/or alternative times, it should be understood that this example is illustrative and therefore should not be construed as being limiting in any way.

The screen display 500F can include various menus and/or menu options (not shown in FIG. 5F). The screen display 500F also can include the order information window 540. According to various embodiments of the concepts and technologies disclosed herein, the order information window 540 can be used to define, view, create, edit, and/or delete various aspects of an order. As can be seen in FIG. 5F, the order information window 540 can include selectable tabs for viewing various order information, where the tabs can be accessible via linked tab titles. Thus, it can be appreciated with reference to FIG. 5F that the order information window 540 can include a custom order characteristic values tab, which can be accessed by selecting the custom order characteristic values option 544; an order line item contacts tab, which can be accessed by selecting the order line item contacts option 546; an order line related items tab, which can be accessed by selecting the order line related items option 548; a service order tab, which can be accessed by selecting the service order option 550; an order tasks tab, which can be accessed by selecting the order tasks option 552; other tabs; and the like.

In the view shown in FIG. 5F, the custom order characteristic values tab is being displayed, for example in response to a user or other entity selecting the custom order characteristic values option 544. Because the custom order characteristic values tab can be shown at additional and/or alternative times, it should be understood that this example embodiment is illustrative, and therefore should not be construed as being limiting in any way. In the custom order characteristic values tab, a custom order values list 542 is being displayed. The custom order values list 542 can be viewed and/or interacted with to determine custom order values and/or to modify these and/or other values. Thus, the order information window 540 can provide and/or enable creation and/or modification of various aspects of an order that is being created by way of interacting with the task management service 110. Because additional or alternative controls can be included in the order information window 540, it should be understood that the example embodiment shown in FIG. 5F is illustrative and therefore should not be construed as being limiting in any way.

FIG. 5G shows an illustrative screen display 500G. According to some embodiments of the concepts and technologies described herein, the screen display 500G can be generated by a device such as the user device 102 and/or the operator device 114 via interactions with the task management service 110 and/or the task management application 108. In particular, according to various embodiments, the user device 102 can generate the screen display 500G and/or other screen displays in conjunction with and/or based upon interactions with the task management service 110 to submit the task data 116 as illustrated and described herein. The user device 102 and/or the operator device 114 can be configured to render the screen display 500G using data generated and/or rendered at the user device 102 and/or the operator device 114 (e.g., using data provided by the task management service 110). In the illustrated embodiment, the screen display 500G can be displayed, for example, in response to a user or other entity selecting the order tasks option 552 shown in FIG. 5F. Because the screen display 500G illustrated in FIG. 5G can be displayed at additional and/or alternative times, it should be understood that this example is illustrative and therefore should not be construed as being limiting in any way.

The screen display 500G can include various menus and/or menu options (not shown in FIG. 5G). The screen display 500G also can include the order information window 540, which has been updated in response to selection of the order tasks option 552 to display the tasks associated with the order. In FIG. 5G, an order task list 554 is shown. The order task list 554 can show all tasks associated with the order being created and/or viewed. The order task list 554 can be interacted with to define, view, create, edit, and/or delete various aspects of an order. Thus, it can be appreciated with reference to FIG. 5G that the order information window 540 can provide and/or enable creation and/or modification of various aspects of an order that is being created by way of interacting with the task management service 110 including, but not limited to, defining and modifying tasks associated with the order. Because additional or alternative controls can be included in the order information window 540, it should be understood that the example embodiment shown in FIG. 5G is illustrative and therefore should not be construed as being limiting in any way.

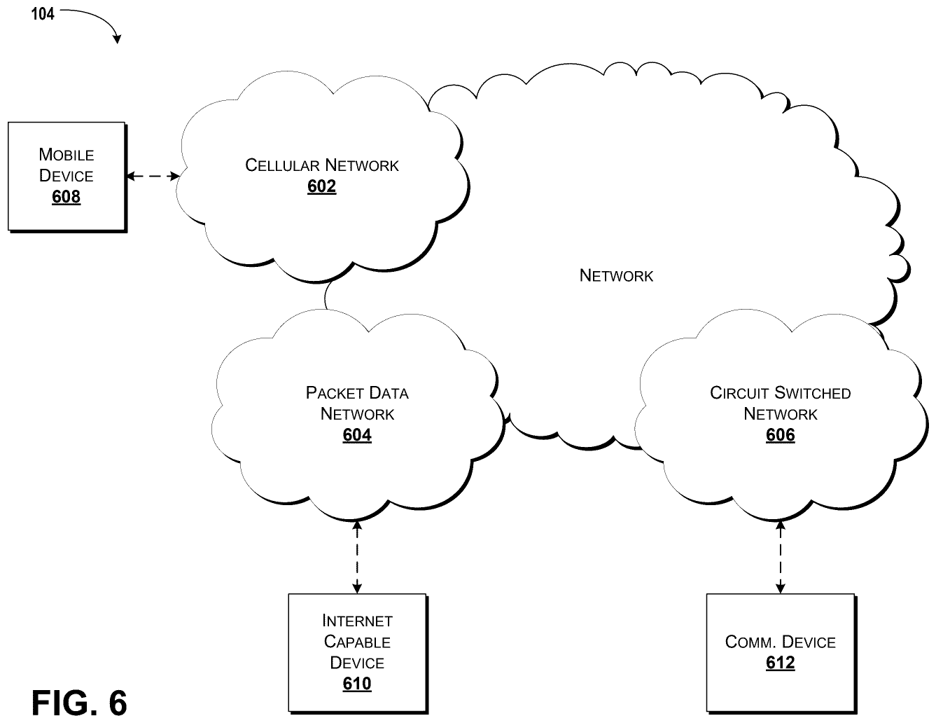

Turning now to FIG. 6, additional details of the network 104 are illustrated, according to an illustrative embodiment. The network 104 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 602 also can include various interfaces between various components, as is generally understood. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSUPA), and HSPA+. The cellular network 602 also is compatible with 4G mobile communications standards, 5G mobile communications standards, 6G mobile communication standards, other mobile communications standards, and evolved and future mobile communications standards.

The packet data network 604 includes various devices, for example, servers, computers, databases, and other devices in communication with one another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (POTS). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 104 is used to refer broadly to any combination of the networks 602, 604, 606. It should be appreciated that substantially all of the functionality described with reference to the network 104 can be performed by the cellular network 602, the packet data network 604, and/or the circuit switched network 606, alone or in combination with other networks, network elements, and the like.

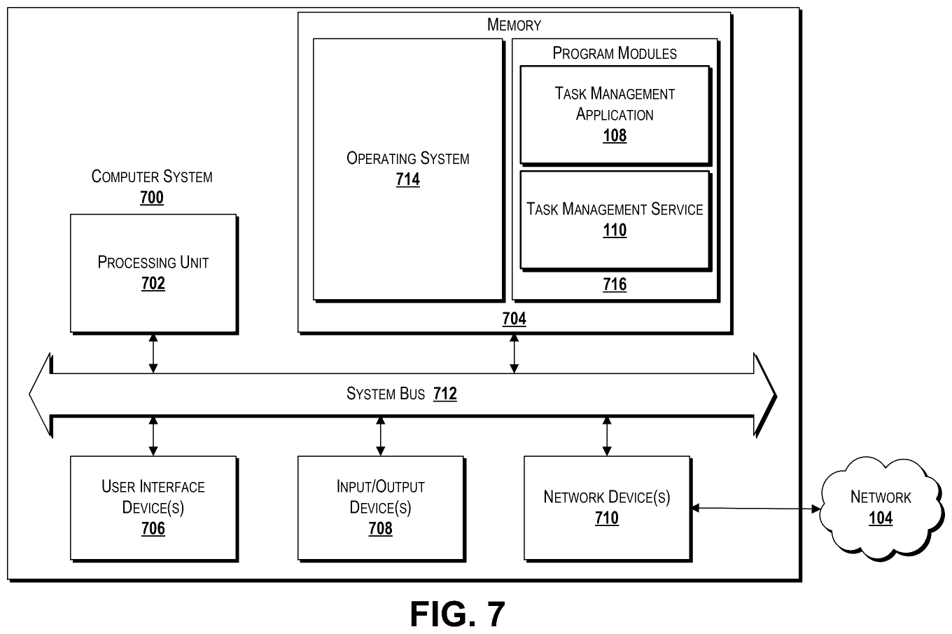

FIG. 7 is a block diagram illustrating a computer system 700 configured to provide the functionality described herein for providing task management using a task management service, in accordance with various embodiments of the concepts and technologies disclosed herein. The computer system 700 includes a processing unit 702, a memory 704, one or more user interface devices 706, one or more input/output (“I/O”) devices 708, and one or more network devices 710, each of which is operatively connected to a system bus 712. The system bus 712 can enable bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. In some embodiments, for example, the program modules 716 include the task management application 108 and the task management service 110. These and/or other programs can be embodied in computer-readable media containing instructions that, when executed by the processing unit 702, perform one or more of the methods 200, 300, and 400 described in detail above with respect to FIGS. 2-4 and/or other functionality as illustrated and described herein. It can be appreciated that, at least by virtue of the instructions embodying the methods 200, 300, and 400, and/or other functionality illustrated and described herein being stored in the memory 704 and/or accessed and/or executed by the processing unit 702, the computer system 700 is a special-purpose computing system that can facilitate providing the functionality illustrated and described herein. According to embodiments, the program modules 716 may be embodied in hardware, software, firmware, or any combination thereof. Although not shown in FIG. 7, it should be understood that the memory 704 also can be configured to store the task data 116 (and/or components thereof including but not limited to the product catalog 118, the template policies 120, the templates 122, the task definitions 124, the logic 126, and/or the execution API 128), the task request 132, the task execution output 134, and/or other data, if desired.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer.

The network devices 710 enable the computer system 700 to communicate with other networks or remote systems via a network, such as the network 104. Examples of the network devices 710 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

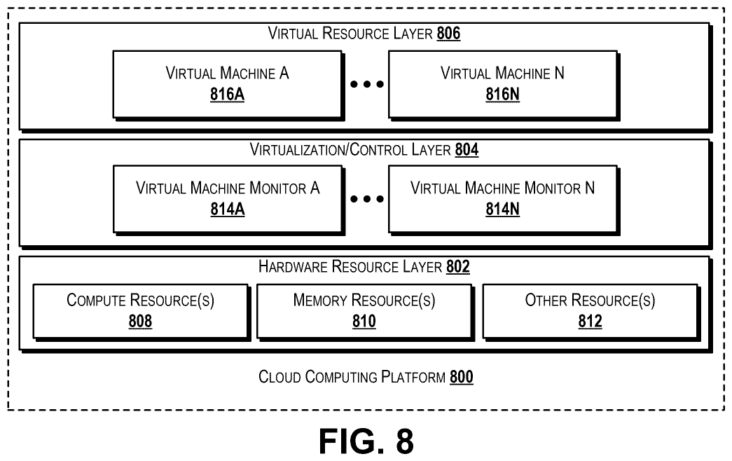

FIG. 8 illustrates an illustrative architecture for a cloud computing platform 800 that can be capable of executing the software components described herein for providing task management using a task management service 110 and/or for interacting with the task management application 108 and/or the task management service 110. Thus, it can be appreciated that in some embodiments of the concepts and technologies disclosed herein, the cloud computing platform 800 illustrated in FIG. 8 can be used to provide the functionality described herein with respect to the user device 102, server computer 112, the operator device 114, and/or the task data repository 130.

The cloud computing platform 800 thus may be utilized to execute any aspects of the software components presented herein. Thus, according to various embodiments of the concepts and technologies disclosed herein, the task management application 108 and/or the task management service 110 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the task management application 108 and/or the task management service 110 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the task management application 108, the task management service 110, or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the task data 116 and/or components thereof (e.g., the product catalog 118, the template policies 120, the templates 122, the task definitions 124, the logic 126, the execution API 128), the task request 132, the task execution output 134, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing task management using a task management service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving a task request from a requestor, wherein the task request comprises data identifying a plurality of tasks that are to be performed as part of an operation,
identifying the plurality of tasks that are identified in the task request,
identifying and retrieving a template policy that relates to a task of the plurality of tasks included in the task request, wherein the template policy is included in task data stored at a task data repository, and wherein the task data is created by an operator device,
identifying and retrieving a template that relates to the template policy, wherein the template is included in the task data stored at the task data repository,
creating the task that is defined by the template,
executing logic that is mapped to the template, wherein the logic is included in the task data stored at the task data repository, and
sending, directed to the requestor, task execution output that is collected by the processor during the executing.

2. The system of claim 1, wherein the task request comprises a task set that comprises the plurality of tasks.

3. The system of claim 1, wherein the template policy comprises a plurality of template policies, and wherein each of the plurality of template policies relates to one of the plurality of tasks.

4. The system of claim 3, wherein the template comprises a plurality of templates, and wherein each of the plurality of templates relates to one of the plurality of template policies.

5. The system of claim 1, wherein executing the logic comprises inputting the logic to an execution application programming interface.

6. The system of claim 1, wherein the computer-executable instructions, when executed by the processor, cause the processor to perform operations further comprising:
obtaining, from the operator device and during a design phase, the task data, wherein the task data further comprises a product catalog, and wherein obtaining the task data comprises providing a portal with a graphical user interface via which the operator device creates the product catalog, the template, the template policy, and the logic.

7. A method comprising:
receiving, by a computer comprising a processor, a task request from a requestor, wherein the task request comprises data identifying a plurality of tasks that are to be performed as part of an operation;
identifying, by the processor, the plurality of tasks that are identified in the task request;
identifying and retrieving, by the processor, a template policy that relates to a task of the plurality of tasks included in the task request, wherein the template policy is included in task data stored at a task data repository, and wherein the task data is created by an operator device;
identifying and retrieving, by the processor, a template that relates to the template policy, wherein the template is included in the task data stored at the task data repository;
creating, by the processor, the task that is defined by the template;
executing, by the processor, logic that is mapped to the template, wherein the logic is included in the task data stored at the task data repository; and
sending, by the processor and directed to the requestor, task execution output that is collected by the processor during the executing.

8. The method of claim 7, wherein the task request comprises a task set that comprises the plurality of tasks.

9. The method of claim 7, wherein the template policy comprises a plurality of template policies, and wherein each of the plurality of template policies relates to one of the plurality of tasks.

10. The method of claim 9, wherein the template comprises a plurality of templates, and wherein each of the plurality of templates relates to one of the plurality of template policies.

11. The method of claim 7, wherein executing the logic comprises inputting the logic to an execution application programming interface.

12. The method of claim 7, further comprising obtaining, from the operator device and during a design phase, the task data.

13. The method of claim 12, wherein the task data further comprises a product catalog, and wherein obtaining the task data comprises providing a portal with a graphical user interface via which the operator device creates the product catalog, the template, the template policy, and the logic.

14. A computer storage medium having computer-executable instructions stored thereon that, when executed by a processor, cause the processor to perform operations comprising:
receiving a task request from a requestor, wherein the task request comprises data identifying a plurality of tasks that are to be performed as part of an operation;
identifying the plurality of tasks that are identified in the task request;
identifying and retrieving a template policy that relates to a task of the plurality of tasks included in the task request, wherein the template policy is included in task data stored at a task data repository, and wherein the task data is created by an operator device;
identifying and retrieving a template that relates to the template policy, wherein the template is included in the task data stored at the task data repository;
creating the task that is defined by the template;
executing logic that is mapped to the template, wherein the logic is included in the task data stored at the task data repository; and
sending, directed to the requestor, task execution output that is collected by the processor during the executing.

15. The computer storage medium of claim 14, wherein the task request comprises a task set that comprises the plurality of tasks.

16. The computer storage medium of claim 14, wherein the template policy comprises a plurality of template policies, and wherein each of the plurality of template policies relates to one of the plurality of tasks.

17. The computer storage medium of claim 16, wherein the template comprises a plurality of templates, and wherein each of the plurality of templates relates to one of the plurality of template policies.

18. The computer storage medium of claim 14, wherein executing the logic comprises inputting the logic to an execution application programming interface.

19. The computer storage medium of claim 14, wherein the computer-executable instructions, when executed by the processor, cause the processor to perform operations further comprising:
obtaining, from the operator device and during a design phase, the task data.

20. The computer storage medium of claim 19, wherein the task data further comprises a product catalog, and wherein obtaining the task data comprises providing a portal with a graphical user interface via which the operator device creates the product catalog, the template, the template policy, and the logic.
